(19) United States
(12) Patent Application Publication
(10) Pub. No.: US 2006/0230135 A1
(43) Pub. Date: Oct. 12, 2006

(54) Simplifying affiliated transactions through an auto-populating web page sub-window

(76) Inventors: James H. Wolfston, West Linn, OR (US); Ben C. Houston, Portland, OR (US)

Correspondence Address: IPSOLON LLP, 111 SW COLUMBIA, SUITE 710, PORTLAND, OR, 97201, US

(21) Appl. No.: 11/105,214

(22) Filed: Apr. 12, 2005

(51) Int. Cl. G06F 15/173

(52) U.S. Cl. 709/224

(57) ABSTRACT

A transaction web page method provides a transaction web page from a first server at a first service address to a user client computer where user-specific transaction information is incorporated into the web page in connection with a first transaction. A transaction sub-window is provided from the first service address in connection with a second transaction that is separate and distinct from the first transaction. The transaction sub-window is rendered adjacent to the transaction web page and is auto-populated with user-specific transaction information from the transaction web page. Upon user activation of the second transaction, transaction information for the second transaction is transmitted to a second server that is at a second service address that is different from the first server service address to provide processing of the second transaction

### TECHNICAL FIELD

The present invention relates to transaction web pages into which users enter identifying and financial information for a selected transaction and, in particular, a transaction web page that further includes an auto-populating sub-window that is auto-populated with the identifying or financial information for a second transaction that is separate from the selected transaction.

### BACKGROUND AND SUMMARY OF THE INVENTION

Charities raise funds in a variety of ways including direct mail or telephone solicitation, organized fundraising events, in-store requests at retailer points-of-sale (e.g., coin or “change” receptacles), requests outside retail locations or other public places (e.g., Holiday coin or “change” buckets), etc. With increases in online shopping and restrictions on charitable solicitation at some retail locations, charitable fundraising within-store requests at retailer points-of-sale and requests at retail location entrances can suffer.

Charitable solicitation at retail location entrances or at retail points-of-sale is independent of and separate from the retail transactions occurring at the hosting retail establishment. The hosting retail establishment does not directly receive any donated funds and so need not account for the donated funds on its accounting records. This relieves the retail establishment of accounting expenses and potential liabilities with regard to the donated funds. In addition, the charitable solicitation does not interfere with completing any transactions at the hosting retail establishment. A customer may choose to drop change into a receptacle at the point-of-sale or the store entrance, but the donation in no way interferes with the transaction with the retail establishment. A key advantage of such charitable donations is that they are typically spontaneous and effortless for the contributor, which makes contributors more likely to donate. A disadvantage of such donations for charities is that they do not receive any identifying information about the contributors and so cannot thank or otherwise communicate with them directly.

Conventional online shopping transactions are incapable of adequately accommodating charitable donations in a manner analogous to charitable solicitation at retail location entrances or at retail points-of-sale. Conventional online transactions employ a transaction web page into which a customer enters identifying information (e.g., name, address, etc.) and financial information (e.g., credit card number, etc.). An aspect of such a conventional transaction web page is that it can communicate with only one server, namely the server from which it originated.

As a consequence, any charitable donations made through such a transaction web page would be carried on the accounts of the online vendor, thereby imposing accounting burdens and liability risks on the online vendor. Alternatively, any link to a separate donation transaction web page served by a separate charity server runs the risk of disrupting completion of the transaction with the online vendor. Online vendors generally would not allow charitable solicitations on their transaction web pages if the solicitations could disrupt completion of the vendor's transactions.

In addition, a link to a separate donation transaction web page would require that the donor again complete at least financial information, and typically also identifying information, because a conventional transaction web page provided from one server (e.g., of an online vendor) is incapable of sharing user transaction information with another server (e.g., of a charity). Entering such information again would undermine the spontaneous and effortless nature of these types of contributions, thereby making them more burdensome and less desirable for contributors.

Accordingly, an aspect of the present invention is a transaction (e.g., donation) sub-window that may be launched as a part of a transaction web page so as to facilitate a separate transaction, such as a charitable donation. A transaction web page from which a sub-window is launched is sometimes referred to as a hosting transaction web page.

The donation sub-window can be provided to a user's computer from the online vendor server that provides the hosting transaction web page thereby minimizing risk that the donation transaction might disrupt the online transaction of the hosting vendor. The sub-window is populated automatically from user transaction information (e.g., identifying information and financial information) entered by the user into the hosting transaction web page. The user merely enters a donation amount into the donation sub-window and accepts the donation, and the user transaction information and donation amount are sent directly to a charitable donation server that is separate from the server for the hosting online vendor. The donation transaction and the transaction of the hosting transaction web page are affiliated with each other in that they are accessed from a common hosting transaction web page, but are processed by different servers.

Generally, browsers prevent information in a web page from being posted to a server at a service address that is different from the service address of the server that provided the web page. In the context of the Internet Protocol (IP), the service address corresponds to the combination of the machine name and the domain, and it functions to uniquely specify a web page source. It will be appreciated that in other network contexts or protocols, the service address that uniquely identifies a page source could be characterized in terminology other than machine name and domain.

As a consequence, a conventional transaction web page would be incapable of providing user transaction information to a separate charitable donation server and a separate vendor server that provided the web page. Some web pages might employ layout structures (e.g., frames) whose pages are loaded from different servers, but such framing consumes fixed real estate within the transaction web page and can distract the user. Further, a framed web page delivered by a separate server does not share data with the transaction web page unless an operating system auto-fill feature is available and turned on at the user's computer.

In contrast, the present invention provides a donation sub-window from a transaction web page that the user receives from an online vendor server. User transaction information in the donation sub-window is delivered to a charitable donation server that is different from the online vendor server. In one implementation, the donation sub-window is generated from a Flash media file (or Flash media object) format (version 7), which provides embedded objects and supports cross-domain posting so that a file received at the user computer from an online vendor server may cross-domain post to a different server, such as the charitable domain server.

Moreover, the donation sub-window is populated automatically from user transaction information in the hosting transaction web page without use of an auto-complete feature that is incorporated in some operating systems. Instead, the auto-population of the donation sub-window is provided by scripting included in the portion of the transaction web page providing the donation sub-window. As a result, the auto-population of donation sub-window is consistent regardless of whether the operating system on the user computer supports and has activated an auto-complete feature.

Furthermore, with it being a part of the hosting transaction web page (i.e., provided from the same vendor server), the donation sub-window avoids problems that would arise if a separate web page from a separate server were loaded. Namely, a separate web page from a separate server usurps the user's focus, leaving the transaction in the hosting transaction web page vulnerable to being forgotten, sidestepped, or dropped. In the context of an online vendor being willing to allow charitable donation from its web site, such an arrangement would fundamentally endanger the completion of vendor transactions. Online vendors would be unlikely to offer such a feature if completion of the vendor's own transactions were at risk.

Also, the donation sub-window of the present invention allows user transaction information to be transmitted to a charitable donation server with the extensive security protections of conventional transactions. In contrast, some methods such as URL-encoding of data from a web to be sent to another server lack the security measures necessary for online financial transactions.

Additional objects and advantages of the present invention will be apparent from the detailed description of the preferred embodiment thereof, which proceeds with reference to the accompanying drawings.

### BRIEF DESCRIPTION OF THE DRAWINGS

FIG. 1 is a simplified illustration of an online transaction web page.

FIG. 2 is a simplified illustration of an online transaction web page with a donation sub-window adjacent to the transaction web page.

FIG. 3 is a block diagram illustrating a computer network as an operating environment for a donation sub-window.

FIG. 4 is a flow diagram of a web page sub-window method embodiment.

### DETAILED DESCRIPTION OF THE EMBODIMENT

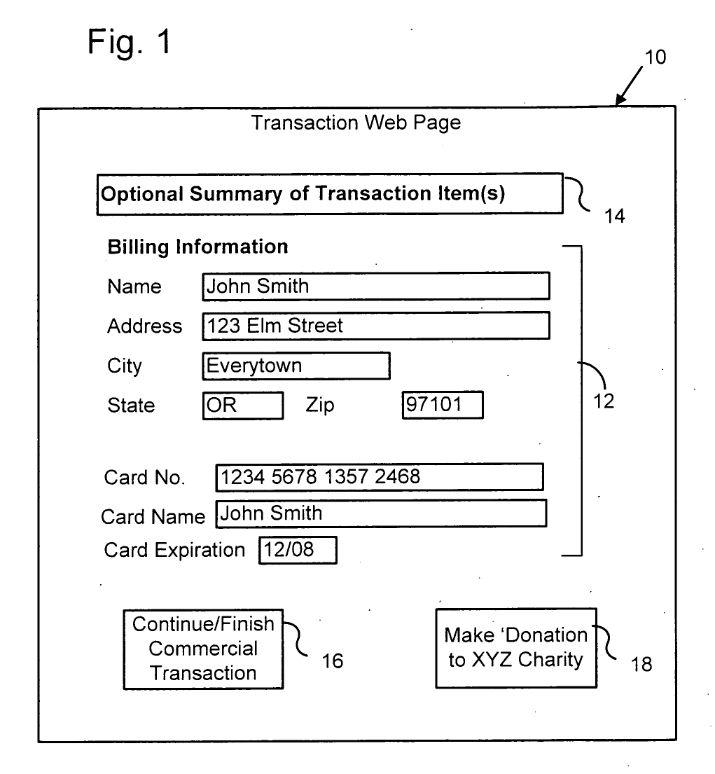

FIG. 1 is a simplified illustration of an online transaction web page 10 illustrating user transaction information 12 that includes identifying information for the user and user financial information. The user transaction information 12 or parts of it may be entered manually by the user or automatically by the user's computer. Web page 10 may include an optional transaction summary 14 (e.g., “shopping cart” listing) of the item or items included in the transaction.

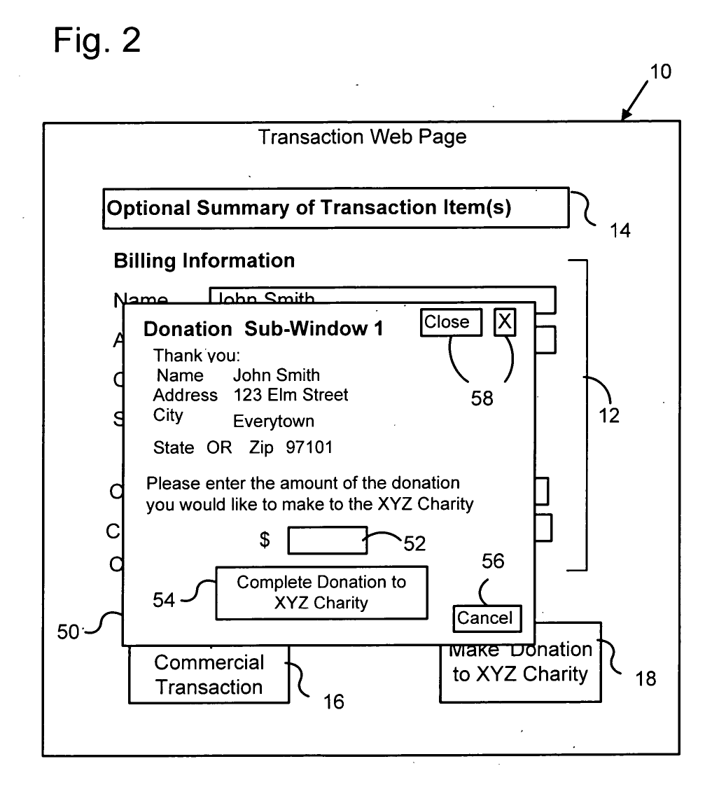

A “Continue/Finish Commercial Transaction” control 16 may be graphically activated by the user to continue or finish the commercial online transaction indicated in transaction web page 10. User activation of “Continue/Finish Commercial Transaction” control 16 continues or finishes the commercial online transaction indicated in transaction web page 10. A “Make Donation to XYZ Charity” control 18 may be graphically activated by the user to make an online “point-of-sale” donation utilizing user transaction information (i.e., user identifying information or user financial information) entered in transaction web page 10. User activation of “Make Donation to XYZ Charity” control 18 defers the commercial online transaction and launches an auto-populated donation sub-window 50 (FIG. 2) in accordance with the present invention.

With reference to FIG. 2, donation sub-window 50 opens adjacent to transaction web page 10. Donation sub-window 50 being adjacent to transaction web page 10 includes sub-window 50 being on top of or next to transaction web page 10, whether overlapping transaction web page 10 or not, but typically with at least part of transaction web page 10 being visible while donation sub-window 50 is open. Sub-window 50 is a part of transaction web page 10, but is formed as a pane, panel or “sub-window” that is adjacent to a standard or base view of transaction web page 10.

Donation sub-window 50 is auto-populated with user transaction information already included in transaction web page 10. User transaction information includes user identifying information (e.g., name, address, etc.) or user financial information (e.g., credit card information). In the implementation of FIG. 2, donation sub-window 50 shows only the identifying information for the user, while the user financial information is recorded by donation sub-window 50, but not shown. In alternative implementations, donation sub-window 50 could show the identifying information and the financial information for the user, or neither the identifying information nor the financial information.

Donation sub-window 50 includes a donation amount block 52 into which the user enters an amount to be donated, and a control 54 to continue or finish the donation to “XYZ Charity.” An optional cancel control 56 allows the user to cancel the donation transaction and close donation sub-window 50. Likewise, optional close controls 58 may allow a user to do the same. Upon user activation of the continue/finish donation control 54, the donation transaction is continued or finished and donation sub-window 50 is closed so that the user is returned to hosting transaction web page 10 (e.g., as shown FIG. 1) to continue the commercial transaction.

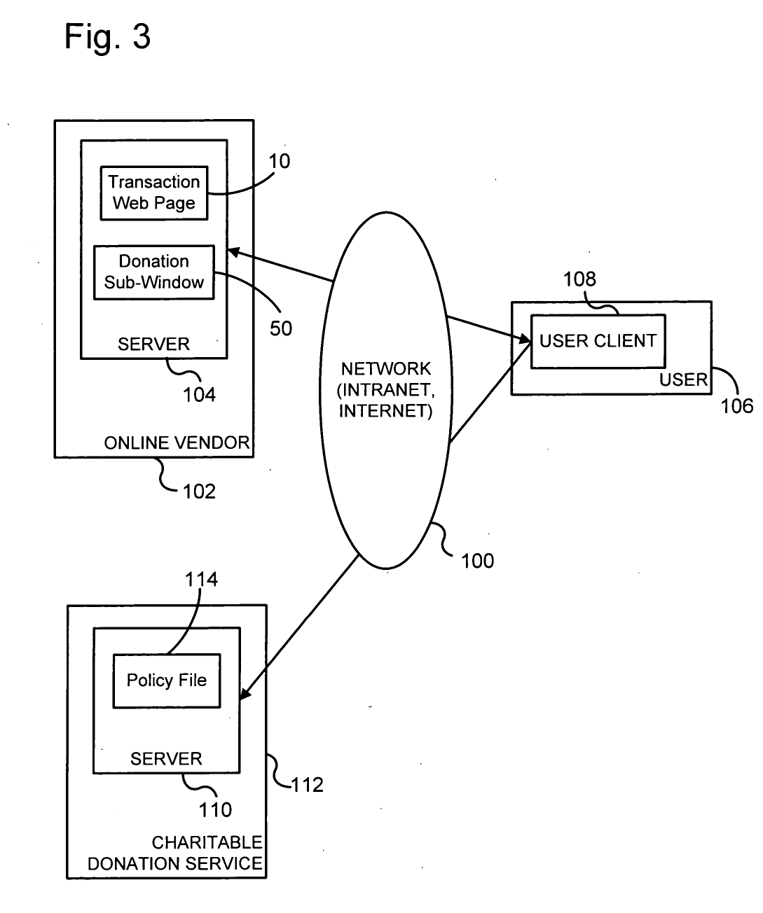

FIG. 3 is a block diagram illustrating a computer network 100 as an operating environment in which donation sub-window 50 is applied. Online vendor 102 provides hosting transaction web page 10 as one of typically many transaction-related pages from one or more servers 104 (one shown). Each of the one or more servers 104 has a shared service address. In the context of the Internet Protocol (IP), the service address corresponds to the combination of the machine name and the domain, and it functions to uniquely specify a web page source. It will be appreciated that in other network contexts or protocols, the service address that uniquely identifies a page source could be characterized in terminology other than machine address and domain.

A user 106 at a user client computer 108 assembles an online transaction from the typically many web pages (not shown) at server 104. The assembled transaction may be summarized at transaction summary 14 (FIG. 1) in hosting transaction web page 10. Transaction web page 10 may be of substantially any file format used for online transactions including, but not limited to HTML, XHTML, WAP, XML, etc. Such a transaction web page 10 may be from one or more servers 104 in accordance with any number of server technologies including, but not limited to PHP, Perl, JSP, ASP, ColdFusion, C, C++, VB.NET, J#, Python, etc. “Make a donation” control 18 (FIG. 1) may be incorporated into transaction web page 10 or may be a linked into transaction web page 10 when it is rendered at user client computer 108 (FIG. 3) in a manner known in the art.

Donation sub-window 50 is of a file format that accommodates or allows cross-domain posting of data, as described below in greater detail. In one implementation, donation sub-window 50 is of a Flash media file (or Flash media object) format version 7 and is supported by Flash Player version 7, which are products of Macromedia, Inc. of San Francisco, Calif. This file format provides embedded objects and supports cross-domain posting so that a file received at user client 108 from vendor server 104 may cross-domain post to a different server, such as a server 110 of a charitable donation service 112. Server 110 is different from server 104 in that server 110 has a service address that is different from the service address of server 104. In the context of the Internet Protocol (IP), the service address corresponds to the combination of the machine name and the domain, and it functions to uniquely specify a web page source. Charitable donation service 112 may be a charitable organization that hosts its own server 110 or may be an application service provider that hosts server 110 on behalf of one or more charitable organizations. It will be appreciated that server 110 may be implemented as one or more server computers.

Donation sub-window 50 as of a Flash media file allows donation sub-window 50 to open on transaction web page 10 without disrupting or shifting from the network connection between user client 108 and vendor server 104. Donation sub-window 50 as of a Flash media file may include software instructions or scripting code, such as Javascript or VBScript, that allows donation sub-window 50 to autopopulate user transaction information 12 from hosting transaction web page 10. Javascript is a scripting language that is adapted to use with Web pages and servers. It will be appreciated that other software or scripting languages could be used.

For example, the software instructions may identify information in specified user-completed fields in transaction web page 10 and copy the information to corresponding fields in donation sub-window 50. The scripting code can be hosted at either the transaction host 104 or the donation host 110. The scripting code can be directly embedded in the transaction web page 10, loaded as an external script through standard methods, injected from the Flash media file itself, or any combination of the above methods or other methods of getting scripts into web pages. For example, the software instructions may identify information in specified user-completed fields in transaction web page 10 and copy the information to corresponding fields in donation sub-window 50.

Upon user activation of continue/finish donation control 54 in donation sub-window 50, cross-domain posting capabilities of the Flash file format allow user transaction information for the donation to be sent directly to server 110 of charitable donation service 112 without passing through vendor server 104. In operation, charity server 110 includes a policy file 114, which establishes that server 110 may receive data from a defined class of files (e.g., Flash media files) originating from a specified server, such as vendor server 104. The defined class of files is selected to correspond to the file type used for donation sub-window 50. The originating server or servers are selected to be the servers of vendors who make donation sub-window 50 available to their online customers, and these servers may be specified according to their service addresses. The user transaction information is sent to charity server 110 in a secure manner, employing for example conventional security measures for transmitting transaction information.

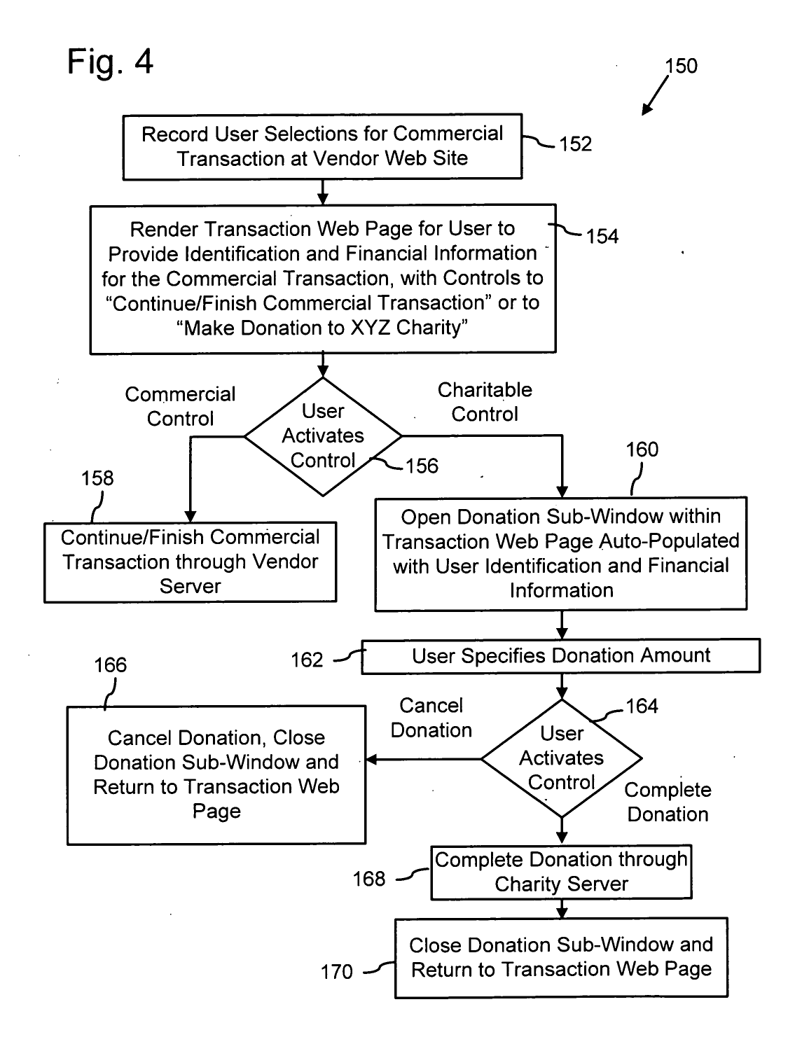

FIG. 4 is a flow diagram of an embodiment of a web page sub-window method 150 that would be implemented by computer based upon software instructions stored in computer-readable media.

In step 152 user selections for a commercial transaction are recorded at a vendor web site in, for example, a “shopping cart.”

In step 154 a transaction web page (e.g., transaction web page 10) is rendered for a user to provide identification and financial information (i.e., user transaction information) for the commercial transaction with the vendor. The transaction web page includes controls to “continue/finish commercial transaction” or to “make donation to charity.”

Step 156 is a decision whether the user activates the “continue/finish commercial transaction” control or the “make donation to charity” control. Step 156 proceeds to step 158 if the user activates the “continue/finish commercial transaction” control and proceeds to step 160 if the user activates the “make donation to charity” control.

In step 158 the commercial transaction is continued or finished through the vendor server.

In step 160 a donation sub-window is opened adjacent to the transaction web page and auto-populated with user identification and financial information from the transaction web page on the user's client computer.

In step 162 the user specifies a donation amount in the sub-window. For example, the user may enter an amount or select from one or more default amounts that are displayed.

At step 164 the user decides to activate the “cancel donation” control or the “continue/finish donation” control. Step 164 proceeds to step 166 if the user activates the “cancel donation” control and proceeds to step 168 if the user activates the “continue/finish donation” control.

In step 166 the donation transaction is cancelled, the donation sub-window is closed, and the user is returned to the transaction web page.

In step 168 the donation transaction is completed through a charity server that is separate and distinct from the vendor server such that the charity server has a different service address than the vendor server.

In step 170 the donation sub-window is closed and the user is returned to the transaction web page.

It will be appreciated that various alternatives could be applied to the present invention. For example, donation control 18 could be non-specific as to the recipient of the charitable donation, and donation sub-window 50 could include a user-selectable field by which the user could indicate which of multiple charities is to receive the donation.

Moreover, self-populating, cross-posting sub-window 50 is described with reference to making charitable donations from within a commercial transaction web page. It will be appreciated that self-populating, cross-posting sub-window 50 could likewise be applied in other applications including, for example, donating to an alumni fund from an education tuition payment page, making an Individual Retirement Account (IRA) contribution from an employee merchandise page, presenting the opportunity to buy an incidental from an affiliated vendor, or making a Federal deficit reduction contribution from tax preparation payment page.

Furthermore, the present invention has been described with reference to a transaction sub-window being auto-populated with user-specified transaction information previously entered into a hosting transaction web page. It will be appreciated that in alternative implementations the hosting transaction web page could be auto-populated with user-specified transaction information previously entered into a transaction sub-window of the present invention. In the context of charitable donations, for example, this would allow user-specified transaction information that is first entered into a donation sub-window to auto-populate a hosting transaction web page.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. A transaction web page method for a transaction web page provided from a first server at a first service address to a user client computer where user-specific transaction information is incorporated into the web page in connection with a first transaction, the improvement comprising:
providing from the first service address a transaction sub-window in connection with a second transaction that is separate and distinct from the first transaction;
rendering the transaction sub-window adjacent to the transaction web page, the transaction sub-window being auto-populated with user-specific transaction information from the transaction web page; and
transmitting transaction information for the second transaction to a second server at a second service address that is different from the first service address to provide financial processing of the second transaction.

2. The method of claim 1 in which following user activation of the second transaction the transaction sub-window is closed and the user is automatically returned to the transaction web page with its user-specific transaction information.

3. The method of claim 1 in which the first server provides no financial processing of the second transaction with respect to the user-specific transaction information.

4. The method of claim 1 in which the second transaction includes a donation to a charitable organization.

5. The method of claim 4 further comprising providing the user a suggested amount for the second transaction.

6. The method of claim 1 in which the transaction sub-window is rendered to overlap at least a portion of the transaction web page.

7. The method of claim 1 in-which the transaction sub-window is auto-populated with user-specific transaction information that includes user financial information.

8. The method of claim 1 in which the transaction sub-window is auto-populated with user-specific transaction information that includes user identifying information.

9. The method of claim 1 in which the second server is operated by an application service provider on behalf of a separate entity that is a party to the second transaction.

10. In a computer readable medium, transaction web page software for a transaction web page provided from a first server at a first service address to a user client computer where user-specific transaction information is incorporated into the web page in connection with a first transaction, comprising:
software for providing from the first service address a transaction sub-window in connection with a second transaction that is separate and distinct from the first transaction;
software for rendering the transaction sub-window adjacent to the transaction web page, the transaction sub-window being auto-populated with user-specific transaction information from the transaction web page; and
software for transmitting transaction information for the second transaction to a second server at a second service address that is different from the first service address to provide processing of the second transaction.

11. The medium of claim 10 further comprising software for closing the transaction sub-window and returning the user to the transaction web page with its user-specific transaction information following user activation of the second transaction.

12. The medium of claim 10 in which the second transaction includes a donation to a charitable organization.

13. The medium of claim 10 further comprising software for providing the user a suggested amount for the second transaction.

14. The medium of claim 10 further comprising software for rendering the transaction sub-window to overlap at least a portion of the transaction web page.

15. The medium of claim 10 further comprising software for auto-populating the transaction sub-window with user-specific transaction information that includes user financial information.

16. The medium of claim 10 further comprising software for auto-populating the transaction sub-window with user-specific transaction information that includes user identifying information.

17. In a computer readable medium, transaction web page software for a transaction web page provided from a first server at a first service address to a user client computer in connection with a first transaction, comprising:
software for providing from the first service address a transaction sub-window in connection with a second transaction that is separate and distinct from the first transaction;
software for rendering the transaction sub-window adjacent to the transaction web page;
software for auto-populating the transaction sub-window or the transaction web page with user-specific transaction information that is incorporated into the transaction sub-window or the transaction web page, respectively;
software for transmitting transaction information for the first transaction to the first server; and
software for transmitting transaction information for the second transaction to a second server at a second service address that is different from the first service address to provide processing of the second transaction.

18. The medium of claim 17 further comprising software for rendering the transaction sub-window to overlap at least a portion of the transaction web page.

19. The medium of claim 17 further comprising software for closing the transaction sub-window and returning the user to the transaction web page with its user-specific transaction information following user activation of the second transaction.
